(19) United States
(12) Patent Application Publication
(10) Pub. No.: US 2010/0218570 A1
(43) Pub. Date: Sep. 2, 2010

(54) COMBINATION LOCK ASSEMBLIES AND METHODS FOR MARKING COMBINATION LOCK ASSEMBLIES INCLUDING RANDOM SELECTION OF CHARACTERS

(76) Inventor: Todd Basche, Los Altos, CA (US)

Correspondence Address: PERKINS COIE LLP;PATENT-SEA, P.O. BOX 1247, SEATTLE, WA, 98111-1247, US

(21) Appl. No.: 12/716,205

(22) Filed: Mar. 2, 2010

Related U.S. Application Data
(60) Provisional application No. 61/156,818, filed on Mar. 2, 2009.

(51) Int. Cl. E05B 37/20; E05B 37/08

(52) U.S. Cl. 70/294; 70/330; 70/291

(57) ABSTRACT

The present disclosure describes tumbler-style combination locks and methods for marking tumbler-style combination locks. The locks include a locking member movable between locked and unlocked configurations with respect to a lock body, a plurality of tumblers individually rotatable with respect to the body and coaxially positioned along an axis, and a plurality of strings of letters corresponding in number to the plurality of tumblers. The letters are randomly selected from an alphabet and positioned on an individual tumbler in a string around the axis.

### CROSS-REFERENCE TO RELATED APPLICATIONS

This application claims priority to and the benefit of U.S. Provisional Patent Application No. 61/156,818, filed Mar. 2, 2009 and titled TUMBLER-STYLE COMBINATION LOCK ASSEMBLIES AND ALGORITHMS FOR MARKING TUMBLER-STYLE COMBINATION LOCK ASSEMBLIES INCLUDING RANDOM SELECTION OF CHARACTERS, which is incorporated herein by reference in its entirety.

### TECHNICAL FIELD

The present disclosure relates to combination locks in which the combination can be freely set or changed to another combination by the user. In particular, the present disclosure relates to combination locks that use letters to spell a word as an unlocking combination of the lock.

### BACKGROUND

Locks are commonly used for securing a wide variety of objects. For instance, locks are frequently used to secure lockers, toolboxes, luggage, bags, gates, doors, containers, bicycles, vehicles and the like. One main disadvantage of a key-based lock is that a physical key is required to open the lock. Another disadvantage of a key-based lock is that a user typically cannot reset or change the key configuration without also replacing the lock.

Combination locks overcome many of the disadvantages of key-based locks by providing a numeric combination instead of a physical key to open the lock. Two common types of numeric based combination locks are rotary-style and tumbler-style locks. Rotary-style locks generally have a rotating dial that displays a range of numbers; whereas conventional tumbler-style locks generally have three to five tumblers or wheels that each display the numbers 0-9. These numeric based combination locks, however, also have many disadvantages. For example, the numeric combination to open the lock is often preset by the manufacturer of the lock. Accordingly, a user is forced to learn an unrelated or random numeric sequence that may be difficult to remember. In addition, even if a user may reset or customize the numeric combination, many users simply have trouble remembering numeric combinations. With a numeric combination lock, if the user forgets the numeric combination the user must typically destroy the lock to open and remove the lock, which can be inconvenient and expensive. Further, as noted above, tumbler-style combination locks typically only display ten numbers (e.g., 0-9) per tumbler, thereby limiting the possible combinations that are available.

Textual combination locks have been developed that allow for a variety of displayed word combinations that are easier for the user to remember. According to one conventional tumbler-style combination lock, letter strings on the tumblers are selected to spell a collection of words. The letter strings on the tumblers can be selected to maximize the number of words in the collection that can be spelled.

The letter strings on the tumblers are selected based on a frequency analysis. In particular, a word collection is analyzed to determine the frequency that each letter occurs. The most frequently occurring letters are selected for the letter string on the tumbler that corresponds to the letter position in the word collection. For example, a collection of three letter words would be analyzed and the ten letters that occur most frequently as the beginning letter of the words in the collection would be selected for the letter string on the first tumbler. Similarly, the ten letters that occur most frequently as the middle and last letters would be selected for the letter strings on the second and third tumblers, respectively.

A tumbler-style textual combination lock also can use a word collection that includes specifically selected related words. It is sometimes the case that a user may find it easier to remember an unlocking combination selected in relation to the application of the lock. For example, a word collection for a lock that is intended to appeal to bicyclists can specifically include words such as “RIDE” or “BIKE.” Alternatively, a word collection can be specifically selected based on an association with a product, an activity, or a marketing promotion. For example, a word collection for a lock that is to be associated with a marketing promotion by a fitness center can include words such as “LIFT” or “WALK.”

Word collections that include specifically selected related words may, however, reduce the number of possible words that can be spelled. In particular, the letter string for one or more of the tumblers will likely need to be adjusted to include a particular letter(s) necessary to spell the specifically selected words. This can skew a frequency analysis from that of a broader word collection. These are some of the factors and can make it easier for an unauthorized person to deduce the word used as the unlocking combination for the lock.

### SUMMARY

Embodiments in accordance with the present disclosure include a tumbler-style combination lock bearing alphabetic letters or symbolic characters on a plurality of tumblers.

Embodiments in accordance with the present disclosure include a textual combination lock bearing alphabetic letters or symbolic characters that spell a word to open the combination lock.

Embodiments in accordance with the present disclosure include a textual combination lock bearing alphabetic letters or symbolic characters to spell abbreviations, expressions, “IM speak” phrases or messages, or other arrangements for communication as a combination to open the combination lock.

Embodiments in accordance with the present disclosure include a textual combination lock including individual tumblers bearing strings of letters that are at least partially selected randomly.

Embodiments in accordance with the present disclosure include a textual combination lock including individual tumblers bearing strings of letters that are partially preselected and partially selected randomly.

Embodiments in accordance with the present disclosure include a textual combination lock include individual tumblers bearing strings of non-duplicative letters that are at least partially selected randomly.

Embodiments in accordance with the present disclosure include a method for marking a textual combination lock including randomly selecting strings of letters for individual tumblers.

Embodiments in accordance with the present disclosure include a method for marking a textual combination lock including randomly selecting strings of non-duplicative letters for individual tumblers.

Embodiments in accordance with the present disclosure include a method for marking a textual combination lock including using a threshold value to ensure a minimum amount of words is spelled.

Embodiments in accordance with the present disclosure include a method for marking a textual combination lock that includes excluding individual objectionable words as possible unlocking combinations.

### BRIEF DESCRIPTION OF THE DRAWINGS

FIG. 1 is a perspective view showing a locked configuration of a combination locking device in accordance with an embodiment of the present disclosure.

FIG. 2A is a perspective view showing an unlocked configuration of the combination locking device shown in FIG. 1.

FIG. 2B is a left side detail view illustrating a process step for changing an unlocking combination of the combination locking device shown in FIG. 2A.

FIG. 3 is a perspective view illustrating another process step for changing an unlocking combination of the combination locking device shown in FIG. 1.

FIG. 4A is a perspective view illustrating another process step for changing an unlocking combination of the combination locking device shown in FIG. 1.

FIG. 4B is a left side detail view illustrating another process step for changing an unlocking combination of the combination locking device shown in FIG. 4A.

FIG. 5 is a chart illustrating an example of character strings for a combination locking device in accordance with an embodiment of the present disclosure.

### DETAILED DESCRIPTION

The following describes embodiments of textual combination locks and methods of manufacturing the locks in accordance with the present disclosure. Embodiments of textual combination locks can include word-based combination locks such as, but are not limited to padlocks, luggage locks, bike locks, and cable locks. Embodiments in accordance with the present disclosure are set forth hereinafter to provide a thorough understanding and enabling description of a number of particular embodiments. Numerous specific details of various embodiments are described below with reference to textual combination locks having alphabetical letters or symbolic characters, but embodiments can be used with other locks and with other indicia. In some instances, well-known structures or operations are not shown, or are not described in detail to avoid obscuring aspects of this invention. A person skilled in the art will understand, however, that the invention may have additional embodiments, or that the invention may be practiced without one or more of the specific details of the embodiments as shown and described.

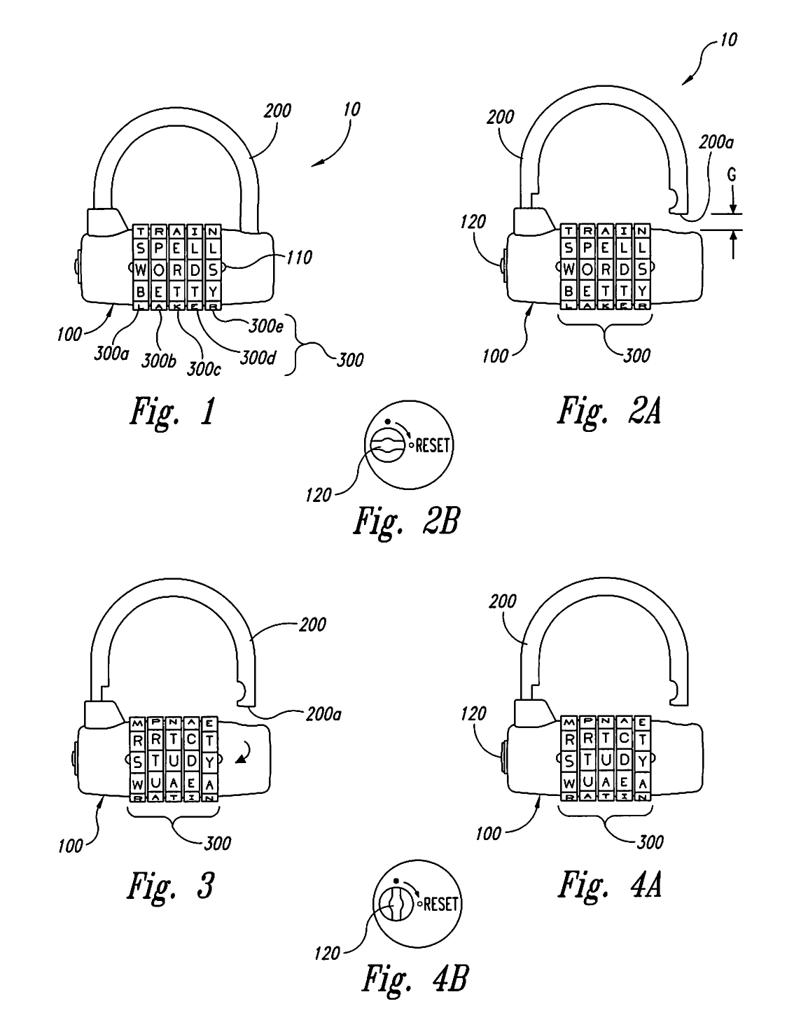

FIG. 1 shows a locked configuration of a textual tumbler-style combination locking device 10 in accordance with an embodiment of the present disclosure. The lock assembly 10 generally includes a body 100, a locking member 200, and a plurality of coaxially positioned tumblers 300 (five individual tumblers 300a-300e are illustrated). The locking member 200, which may be a hasp, a shackle, or another suitably strong member, is operatively coupled to the body 100 such that the locking member 200 can move between the locked configuration shown in FIG. 1 and an unlocked configuration (See FIGS. 2-4). In the embodiment shown in FIGS. 1-4, the movement between the locked and unlocked configurations includes displacing and pivoting the locking member 200 with respect to the body 100. The tumblers 300 are individually rotatable with respect to the body 100.

Other embodiments according to the present disclosure can use less than or more than five individual tumblers. The number of tumblers can affect the number of unlocking combinations that are available, the complexity of the locking mechanism, and/or the likelihood that an unauthorized person can deduce the unlocking combination. For example, reducing the number of tumblers increases the absolute number of combinations that are possible, i.e., regardless of whether each combination spells a word. Similarly, increasing the number of tumblers can increase the number of letters in an unlocking combination word and therefore decrease the number of words that could possibly be spelled with the limited strings of letters that are available on each tumbler. Moreover, connecting additional tumblers to the locking mechanism can increase the complexity and therefore the cost of the lock.

According to other embodiments of the present disclosure, certain potentially adverse effects of increasing the number of tumblers may be mitigated by (1) using a phrase for the unlocking combination and/or (2) using dummy tumblers. Selecting a phrase that, for example, includes two short words as opposed to one long word as the unlocking combination can increase the number of words that could possibly be spelled with the strings of letters that are available on each tumbler. A two word phrase for the unlocking combination can be facilitated by including a blank in one or more of the strings for intermediate tumblers. Dummy tumblers or tumblers that are included in the plurality of tumblers but are not operatively coupled to the locking mechanism can also increase the number of words that could possibly be spelled with the strings of letters that are available on each tumbler. For example, including a blank in each of the strings for the individual tumblers can obfuscate which tumblers are used to spell the unlocking combination.

FIG. 2A shows the unlocked configuration of the device 10. A gap G is provided between the body 100 and a free end 200a of the locking member 200 in the unlocked configuration of the device 10. An object (not shown) that is to be secured by the device 10 can be moved relative to the device 10 so as to pass through the gap G.

To move to the locked configuration of the device 10, the locking member 200 can be moved, e.g., displaced, translated, pivoted, rotated, or a combination thereof, such that the free end 200a engages with the body 100. In other embodiments, the free end 200a is positioned in such proximity to the body 100 as to reduce or eliminate the gap G. Accordingly, in the locked configuration of the device shown in FIG. 1, the object (not shown) that is being secured cannot pass between the body 100 and the free end (not shown in FIG. 1) of the locking member 200. The body 100 may also include an indicator 110 (e.g., a notch, protrusion, arrowhead, line, etc.) positioned on the body 100. In several embodiments, the indicator 110 identifies to a user where to rotatably position the tumblers 300 with respect to the body 100 so as to transition at least from the locked configuration of the device 10 to the unlocked configuration of the device 10.

A process for setting a new unlocking combination will now be described with respect to FIGS. 1-4B. To begin, the character strings on the individual tumblers 300a-300e are reviewed to ascertain the characters available on each of the tumblers 300. The new unlocking combination can be any word that can be spelled starting with one of the letters on the tumbler 300a, and continuing with one of the letters on each of the tumblers 300b-300e, respectively.

The tumblers 300 are then rotated to spell the current unlocking combination, e.g., as provided by the manufacturer. Specifically, the tumblers 300a-300e are individually rotated to spell the current unlocking combination in alignment with the indicator 110 (e.g., “WORDS” in the embodiment shown in FIGS. 1 and 2A). The device 10 can now be opened by moving the locking member 200 to the unlocked configuration, e.g., to produce the gap G between the free end 200a and the body 100. Referring to FIG. 2B, a flat tool or a coin can be used to rotate a slot 120 to point to a “RESET” position on the body 100.

The tumblers 300 are then rotated to spell the new unlocking combination. Specifically, the tumblers 300a-300e are individually rotated to spell the new unlocking combination in alignment with the indicator 110. Referring to FIG. 4B, the slot 120 can be rotated back to its original position, thereby setting the new unlocking combination, and the locking member 200 can be moved to the locked configuration (See FIG. 1). Accordingly, the original locking combination has been reset with the new locking combination (e.g., “STUDY” in the embodiment shown in FIGS. 3 and 4A).

The words that are available to be used as an unlocking combination are defined by the strings of letters on the individual tumblers 300a-300e. According to embodiments of the present disclosure, a string of ten letters is randomly selected from an alphabet, e.g., A-Z, for each tumbler 300. In other embodiments, a string of letters on an individual tumbler can include more or less than ten letters, and can be selected from any suitable alphabet, e.g., Spanish, Greek, Cyrillic, Braille, etc. In some embodiments, the alphabet can be considered to additionally include a null or blank character as discussed above. In still other embodiments, a character group can include one or more of alphabetic characters, numeric characters, symbols, colors, shapes or any suitable distinguishable characteristic.

An individual series of randomly selected letters can be provided by a random letter generator, e.g., a computational or physical device designed to generate a sequence of letters (or a blank) that lacks any pattern, i.e. appears random. Computational random generators and physical random generators are well known and no further details are necessary for understanding the present disclosure. In one embodiment, the letters or characters for each tumbler are randomly selected. In another embodiment the letters or characters for one tumbler is randomly selected. The other tumblers can include the same randomly generated letters or characters from the first tumbler. In yet another embodiment, the letters or characters for more than one tumbler can be randomly generated as discussed herein, and the remaining tumblers can either duplicate one or more of the randomly generated sequences of letters or characters, or the remaining tumblers may have specifically selected and ordered (i.e., non-random) sequences of letters or characters.

According to embodiments of the present disclosure, duplicate characters on an individual tumbler 300a-300e are prevented. In some embodiments, duplicate characters can be prevented by excluding from the random letter generator those characters that have already been randomly selected for a character string on an individual tumbler 300a-300e. According to embodiments of the present disclosure, there is no prohibition against duplicate characters in character strings for different tumblers 300.

According to some embodiments of the present disclosure, one or more characters (including, for example, blanks) can be preselected for one or more character strings. The remaining characters in the individual strings can then be randomly selected as discussed above. In other embodiments according to the present disclosure, the character strings can include different portions of preselected and randomly selected characters for the individual tumblers 300a-300e.

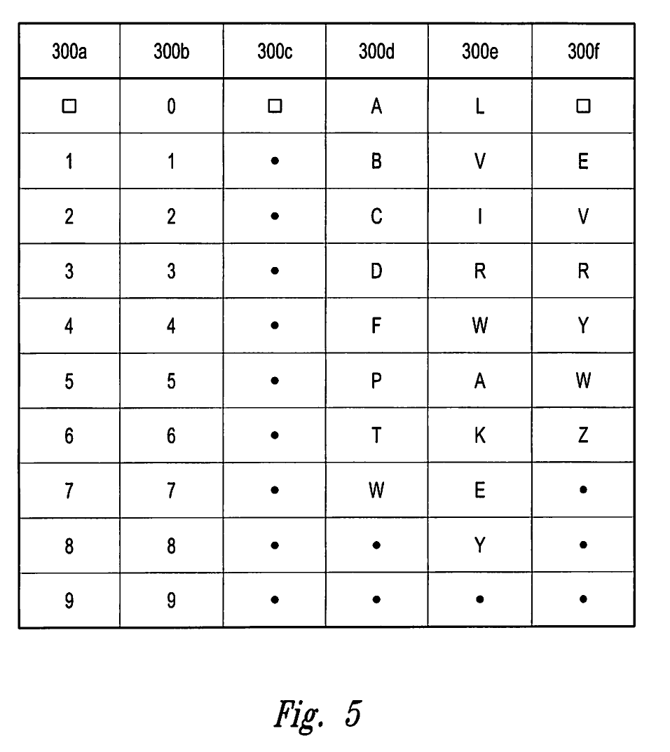

FIG. 5 illustrates one example of a device 10a according to an embodiment of the present invention. The device 10a includes six tumblers 300a-300f that include individual strings of ten characters. The individual character strings shown in FIG. 5 include letters, blanks and/or numbers. The individual character strings shown in FIG. 5 also include different portions of preselected and randomly selected characters. One or more of the six tumblers 300a-300f also can be a dummy tumbler(s) that would not be operably connected to the lock mechanism (not shown). Specifically, the character strings for the first tumbler 300a is entirely preselected to identically include the numbers 1-9 and a blank. The presence of a blank is illustrated with “□” in FIG. 5. The character string for the second tumbler 300b is entirely preselected to include the numbers 0-9. The character string for the third tumbler 300c includes a single preselected character (□), with the rest of the character string being randomly selected from a character group including the alphabet (A-Z) and integers (0-9). The presence of a randomly selected character is illustrated with “•” in FIG. 5. The character string for the fourth tumbler 300d includes eight preselected characters (A, B, C, D, F, P, T and W) and two characters being randomly selected from a character group including the alphabet (A-Z). The character string for the fifth tumbler 300e includes nine preselected characters (L, V, I, R, W, A, K, E and Y) and one character being randomly selected from a character group including the alphabet (A-Z). The character string for the sixth tumbler 300f includes seven preselected characters (□, E, V, R, Y, W and Z) and three characters being randomly selected from a character group including the alphabet (A-Z).

The unlocking combination in the embodiment shown in FIG. 5 can be selected by the user based on remembering a street designation. Specifically, the character strings for the first, second and third tumblers 300a-300c can be selected to designate a one digit street number (e.g., selecting the blank “□” in the character strings for the first and third tumblers 300a and 300c), a two digit street number (e.g., selecting numbers in the character strings for the first and second tumblers 300a and 300b, and selecting the blank “□” in the character string for the third tumbler 300c), or a three digit street number (e.g., if the randomly selected characters include a number). Letters in the character strings for the fourth and fifth tumblers 300d and 300e can be selected to designate two letter street abbreviations (e.g., AV, BV, CI, DR, FW, PW, PL, TE or WY). Similarly, the character strings for the fourth, fifth and sixth tumblers 300d-300f can be selected to designate three letter street abbreviations (e.g., AVE, BLV, CIR, DRV, FWY, PKW, PLZ, TER or WAY). Accordingly, examples that a user could select as the unlocking combination include at least “14□AV□” (or “14□AVE”) and recalling the unlocking combination by remembering 14th Avenue. For the embodiment according to FIG. 5, there are more than 2,100 available unlocking combinations from which a user can choose, and that is without considering additional possibilities enabled by the randomly selected characters.

Further, the third tumbler 300c can be a dummy tumbler and the user would retain at least the same number of available combinations. The third and sixth tumblers 300c and 300f can be dummy tumblers and the user would still have more than 1,200 available unlocking combinations from which to choose.

Other examples in accordance with the present invention can include a device 10 having five individual tumblers 300 with the entirety of the individual character strings being randomly selected from the alphabet (A-Z). The number of available unlocking combinations from which to choose would depend on the length of the individual character strings and the letters randomly selected for the individual character strings. Still other examples in accordance with the present invention can include devices with different numbers of tumblers, different lengths of character strings, and the portions of the individual character strings that are preselected and randomly selected, as well as the characters that are randomly selected and the size of the groups from which characters are selected. Further securing the device against unauthorized users deducing the unlocking combination is the likelihood that only the user would know the context of the unlocking combination, e.g., street designations.

In accordance with embodiments of the present disclosure, methods for marking tumbler-style combination locks can include randomly selecting characters for an individual tumbler. The methods can include utilizing one or more algorithm operable via a conventional computer system. In at least one embodiment, a first character for a first tumbler is randomly selected from a group of characters that can include alphabetic characters, numeric characters, symbols, colors, shapes, blanks or any suitable distinguishable characteristic. A second character for the first tumbler is randomly selected from a second group of characters. The second character group can include the first character group without the first character that was randomly selected for the first tumbler. According to other embodiments of the present disclosure, a method for marking tumbler-style combination locks can additionally include randomly selecting characters for a second tumbler. A first character for a second tumbler is randomly selected from a group of characters that can include the first character group. A second character for the second tumbler is randomly selected from a third group of characters. The third character group can include the first character group without the first character that was randomly selected for the second tumbler. According to still other embodiments of the present disclosure, a method for marking tumbler-style combination locks can additionally include repeating randomly selecting all of the characters for the individual tumblers. The repeated random selection provides character lists for the individual tumblers and individual character lists exclude duplicate characters.

According to another embodiment, a method for marking tumbler-style combination locks can include randomly selecting all of the characters for the individual tumblers as disclosed above and then determining the number of words that the set of selected characters is capable of spelling. Some sets of randomly selected characters will be able to spell a relatively small number of words, and other sets of randomly selected characters will be able to spell a relatively large number of words. In at least one embodiment, the random selection step is configured so that once a character is selected for a tumbler, that character is restricted from being selected again for use on that tumbler. Accordingly, a character can not be repeated on a single tumbler in a randomly selected set of characters. This random selection process is such that the number of words that can be spelled by each set of randomly selected characters can be then compared to a threshold value. In one embodiment, the threshold value is related to the number of words that a set of characters must be able to spell for the set of characters to be suitable for actual use on a lock assembly. In one embodiment, the numerical threshold value is 500 words, although other embodiments can have any other selected threshold value, e.g. 300, 750, 832, 1000, etc.

If the number of words that can be spelled by the set of letters associated with each tumbler position is less than the threshold value, the step repeats and another set of characters for the individual tumblers is generated, and the number of words that can be spelled by the new set of characters is compared to the threshold value. When a set of selected characters is generated that can spell equal to or more words than the threshold value, a list of these words can be reviewed to determine if they are acceptable for actual use on a lock assembly. If the collection of words are not acceptable or for any other reason are not desirable for use on the lock assembly, then further sets of selected characters for the tumblers can be randomly generated as discussed above. This process for selecting the characters for some or all of the positions on the tumblers of the lock assembly can greatly reduce the design and manufacture time, thereby reducing cost of the lock assembly.

According to yet another embodiment, a method for making tumbler-style combination locks can include preselecting at least one or all of the characters for one or more tumblers, such as the first tumbler. For example, the characters may be selected by choosing generally known or specifically determined commonly used first letters of words. The remaining characters for the other positions on the tumblers can be generated using random selection until the characters for all of the positions on the tumblers are selected. In one embodiment, the random generation of remaining characters can follow the random selection/comparison process as discussed above. For example, the number of words the selected characters are capable of spelling can be compared to a threshold value. If the number of words does not meet the threshold value, the step repeats itself by randomly selecting characters but not changing the preselected character(s). Repeating the step may include at least one of randomly selecting a new character for a character list on an individual tumbler, randomly selecting a new character list on an individual tumbler, and randomly selecting an entirely new set of characters without changing the preselected character(s). The step can repeat itself until at least the threshold value is met and/or an acceptable list of words that can be spelled is obtained.

According to further embodiments of the present disclosure, a method for marking tumbler-style combination locks can additionally include excluding objectionable words from a list of possible unlocking combinations. The excluded words can include words that are deemed to be vulgar, explicit, inappropriate or otherwise objectionable.

From the foregoing, it will be appreciated that specific embodiments of the invention have been described herein for purposes of illustration, but that various modifications can be made without deviating from the spirit and scope of the invention. Accordingly, the invention is not limited by the specific embodiments.

What is claimed is:

1. A method of marking a combination lock including a plurality of coaxial tumblers, the method comprising:
randomly selecting a first character for a first one of the plurality of tumblers and applying the randomly selected first character to a first position on the first one of the plurality of tumblers, the first character for the first tumbler being randomly selected from a first group of characters including alphabetic characters, numeric characters, symbols, colors, shapes and blanks; and
randomly selecting a second character for the first tumbler and applying the randomly selected second character to a second position on the first one of the plurality of tumblers, the second character for the first tumbler being randomly selected from a second group of characters, the second character group including the first character group without the first character for the first tumbler.

2. The method of claim 1 further comprising:
randomly selecting a first character for a second one of the plurality of tumblers and applying the randomly selected first character to a first position on the second one of the plurality of tumblers, the first character for the second tumbler being randomly selected from the first character group; and
randomly selecting a second character for the second tumbler and applying the randomly selected second character to a second position on the second one of the plurality of tumblers, the second character for the second tumbler being randomly selected from a third group of characters, the third character group including the first character group without the first character for the second tumbler.

3. The method of claim 2 further comprising repeating randomly selecting additional characters for individual tumblers from character groups that exclude already selected characters.

4. The method of claim 2 further comprising repeating randomly selecting characters for each of the plurality of tumblers.

5. A method of marking a combination lock including a plurality of tumblers, each tumbler having a plurality of positions for characters, comprising:
randomly selecting characters for each position on each of the tumblers, wherein the characters are selected from a group of characters including alphabetic characters, the randomly selected characters defining a first set of characters;
determining a first number of words capable of being spelled from the first set of characters using any arrangement of the characters using one character from each tumbler at a time; and
comparing the first number of words to a threshold to determine whether the threshold is met or exceeded.

6. The method of claim 5, further comprising:
repeating randomly selecting the characters each position on each of the tumblers to define a second set of characters;
determining a second number of words capable of being spelled from the second set of characters using any arrangement of characters using one character from each tumbler at a time;
comparing the second number of words to the threshold to determine whether the threshold value is met; and
applying one of the sets of characters to the plurality of positions on the tumblers.

7. The method of claim 5 wherein the threshold is numerical threshold value that comprises a minimum number of words that can be spelled by the randomly selected characters, and wherein comparing the first number of words to the threshold value includes determining whether the first number of words meets or exceeds the minimum number of words.

8. The method of claim 5, further comprising preselecting at least one character for application to one of the tumblers and then randomly selecting the rest of the characters for the first and second sets of characters.

9. The method of claim 5, further comprising preselecting the characters for all of the positions for at least one the tumblers, and randomly selecting the rest of the characters.

10. The method of claim 5, further comprising preselecting the characters for the positions for the first tumbler to form first letters of the words.

11. The method of claim 5 further comprising:
repeating randomly selecting characters for a plurality of sets of characters, determining how many words each of the sets of characters can spell, and comparing the number of words to the threshold until the threshold is met or exceeded.

12. An method for marking a tumbler-style combination lock including a plurality of coaxial tumblers, the method comprising:
randomly selecting a first letter for a first one of the plurality of tumblers, the first letter for the first tumbler being randomly selected from an alphabet;
randomly selecting a second letter for the first tumbler, the second letter for the first tumbler being randomly selected from the alphabet excluding the first letter for the first tumbler;
repeating randomly selecting additional letters for the first tumbler to complete a first string of letters for the first tumbler, wherein the first string of letters for the first tumbler does not include duplicate letters;
randomly selecting a first letter for a second one of the plurality of tumblers, the first letter for the second tumbler being randomly selected from the alphabet;
randomly selecting a second letter for the second tumbler, the second letter for the second tumbler being randomly selected from the alphabet excluding the first letter for the second tumbler;
repeating randomly selecting additional letters for the second tumbler to complete a second string of letters on the second tumbler, wherein the second string of letters on the second tumbler does not include duplicate letters;
repeating randomly selecting additional strings of letters for each of the plurality of tumblers, wherein individual strings of letters do not include duplicate letters; and
marking individual strings of letters on individual tumblers.

13. A method of marking a combination lock including manipulatable member and a lock body, the method comprising:
randomly selecting a first character and applying the randomly selected first character to a first position on at least one of the manipulatable member and the lock body, the first character being randomly selected from a first group of characters including alphabetic characters, numeric characters, symbols, colors, shapes and blanks;
randomly selecting a second character and applying the randomly selected second character to a second position on at least one of the manipulatable member and the lock body, the second character being randomly selected from a second group of characters, the second character group including the first character group without the first character for the at least one of the manipulatable member and the lock body; and
repeating randomly selecting additional characters for the at least one of the manipulatable member and the lock body from character groups that exclude already selected characters.

14. The method of claim 13 further comprising selecting at least one character for application on the at least one of the manipulatable member and the lock body.

15. The method of claim 13 wherein the manipulatable member is a set of tumblers.

16. A combination lock, comprising:
a locking member movable between locked and unlocked configurations with respect to a lock body; and
a manipulatable member capable of being manipulated by a user, movable with respect to the lock body wherein at least one of the manipulatable member and the lock body having characters thereon that are randomly selected from a group of characters including at least one of alphabetic characters, numeric characters, symbols, colors, shapes and blanks, wherein the characters are used in connection with an unlocking combination of the locking member.

17. The combination lock of claim 16 wherein the manipulatable member includes characters selected from a group consisting of an alphabet and blanks.

18. The combination lock of claim 16 wherein all of the characters on the manipulatable member are randomly selected from the group of characters.

19. The combination lock of claim 16 wherein one character is preselected in a non random manner and the rest of the characters are randomly selected from the group of characters.

20. The combination lock of claim 16 wherein one character on the manipulatable member is preselected in a non-random manner and the rest of the characters on each of the individual tumblers are randomly selected from the group of characters.

21. The combination lock of claim 16 wherein a first portion of the characters are preselected in a non random manner and a second portion of the characters are randomly selected from the group of characters.

22. The combination of claim 16 wherein a first portion of the characters on the manipulatable member is preselected in a non-random manner and the rest of the characters on the manipulatable member is randomly selected from the group of characters.

23. The combination lock of claim 16 wherein the manipulatable member is a set of tumblers.

24. The combination lock of claim 16 further comprising a dummy tumbler.

25. A combination lock, comprising:
a locking member movable between locked and unlocked configurations with respect to a lock body;
a plurality of tumblers individually rotatable with respect to the body, the plurality of tumblers being coaxially positioned along an axis;
a plurality of sets of letters corresponding in number to the plurality of tumblers, individual sets of letters being at least partially randomly selected from an alphabet and positioned on an individual tumbler in a string around the axis, wherein a combination to move the locking member to the unlocked configuration includes a word spelled by an alignment of letters on the plurality of tumblers.
